(19) United States
(12) Patent Application Publication
(10) Pub. No.: US 2007/0273912 A1
(43) Pub. Date: Nov. 29, 2007

(54) Prediction of consumable usage in a mail processing system

(76) Inventor: Denis Maurin, Milford, CT (US)

Correspondence Address: KENYON & KENYON LLP, 1500 K STREET N.W., SUITE 700, WASHINGTON, DC, 20005, US

(21) Appl. No.: 11/441,772

(22) Filed: May 26, 2006

(51) Int. Cl. G06K 15/00

(52) U.S. Cl. 358/1.14

(57) ABSTRACT

A mail processing system includes one or more processing devices operative to perform executable operations. The system further includes or accesses numerous devices containing consumable items used therein. In the mail processing system, the operating speed of the system is calculated using one or more various profile techniques. The system also determines the remaining capacity or amount of the consumable in the system. Based on the computed operating speed, the system calculates a prediction term predicting the expiration of the corresponding consumable. From this prediction term, an estimated time to expire is computed to predict when the consumable will expire, thereby insuring any mailing projects may be timely completed.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### BACKGROUND OF THE INVENTION

The present invention relates generally to mail processing systems and more specifically to the monitoring and predicting of the usage of consumable components within these processing systems.

In modern high speed print and postage systems, voluminous print jobs can be executed in one or more batches. The execution of these print jobs includes printing one or more documents to be mailed, printing envelopes, printing postage on the envelopes and in some instances inserting the mailing into the envelope for subsequent mailing. Many benefits are realized with these high speed processing systems, but concurrent with the high volume of work product, there are issues relating to the supply of consumable items within the mail processing system. Consumable items include the elements utilized by the processing system that need replenishment, such as, but not limited to, paper, ink, labels, envelopes and other components, such as replaceable parts as belts, pulleys, etc. Therefore, when executing a project on these processing systems, it can be beneficial to be able to know when the supply of one or more consumable items are about to expire and thereby not interrupt the execution of the project.

In existing processing systems, the supply amounts of these consumable items are monitored and tracked by relatively primitive techniques. One available technique is to simply monitor the remaining amounts based on an item level indicator. For example, tracking the amount of ink left in the print system may include visually inspecting an ink quantity indicator, such as indicating the cartridge has 50% of its capacity left. In another technique, the cartridge levels may be associated with a printing amount, such as a set number of pages, but since each printed page requires differing amounts of ink, this is very unreliable.

Another notification technique to track the remaining quantities of different consumable items, or wear of sensitive replaceable parts, is utilizing alarms or other types of notifications to alert an end user or processing system if the consumable item gets below a prescribed or threshold level. In the example of ink, one technique may include sounding an alarm or providing a warning notification if the ink level is below a threshold amount, for example below 10%. In the example of an ink cartridge, this many include a command for the user to refill or replace the depleted cartridge.

These existing techniques are reactionary techniques providing a response to a threshold situation. In the above example of ink, notifications are provided when ink levels are below the threshold. In the high volume mail processing systems, this can be problematic due to the printing speed and subsequent volume of consumable usage.

Another example of a consumable item may be credit within a postage security device (PSD). As well known, the PSDs provide secured credit for the printing of a valid postage usable by the Postal system. The same reactionary techniques as described above can be used with the PSDs.

It is also known to proactively calculate consumable amounts based optimized operating speeds of the printing device. For example, a user can manually calculate that the postage printing device can process, at a maximum speed, 5000 envelopes per hour. If a project is estimated to run for two hours, the user may estimate a maximum amount of 10,000 envelopes. While these mail processing systems have optimum operating speeds, this can be a very inaccurate indicator for consumable usage because the machines operate at speeds significantly varying from the optimized amount.

Aside from the known reactionary techniques or the widely inaccurate proactive technique of estimating usage, the mail processing systems do not predict when the supply of one or more of the various consumable items will expire, as conditioned by variables as throughput, material processed, run times, idle times, end item content makeup, repeated job interruptions. To this end, it would be desirable to design a mail processing system with, not only the ability to predict consumable usage sufficiently to assure a consumable is in inventory prior to its need, but also to minimize the lead time on the consumable replacement and to lessen inventory overhead. Further, it would be desirable to design the mail processing system with the ability to learn the variabilities of the projects being run such that, over time, the consumable(s) being monitored can statistically be subjected to more precise replenishment lead time to minimize delays in the logistics system.

### BRIEF DESCRIPTION OF THE DRAWINGS

FIG. 1 illustrates a block diagram of one embodiment of a mail processing system allowing for the prediction of the usage of consumable items therein;

FIG. 2 illustrates a block diagram of a processing component disposed within the system of FIG. 1;

FIG. 3 illustrates a flow diagram of one embodiment for predicting usage of a consumable in a mail processing system;

FIG. 4 illustrates a flow chart of the steps of one embodiment of a method for predicting usage of a consumable in a mail processing system;

FIG. 5 illustrates a printing environment allowing for the prediction of the usage of consumable items therein;

FIG. 6 illustrates another embodiment of a mail processing system allowing for the prediction of the usage of consumable items therein;

FIG. 7 illustrates a flow chart of the steps of another embodiment of a method for predicting usage of a consumable in a mail processing system; and

FIG. 8 illustrates a chart of a sample usage profile.

### DETAILED DESCRIPTION

Briefly, a mail processing system can include one or more processing devices operative to perform executable operations. The mail processing system can further include or access numerous devices containing consumable items used therein. In the mail processing system, which may include a printing component, the operating speed of the device can be calculated using one or more various techniques. The mail processing system can also determine the remaining capacity or amount of the consumable in the system, the rate at which one or more consumables are actually being expended and the actual operating rates of one or more parts of the processing system. Based on the monitored actual operating speed and/or historical data, such as actual past usage rates of a given consumable, the postage printing system can calculate a prediction term for predicting the expiration of the corresponding consumable for the present and or/future print jobs. From this prediction term, an estimated time at the end of which the consumable may be expected to expire can be computed. This can enable the operator to provide sufficient consumables and to prevent a consumable from running out during a processing job or a print job, thereby preventing a disruption of the job while the consumable is replaced and the job is resumed.

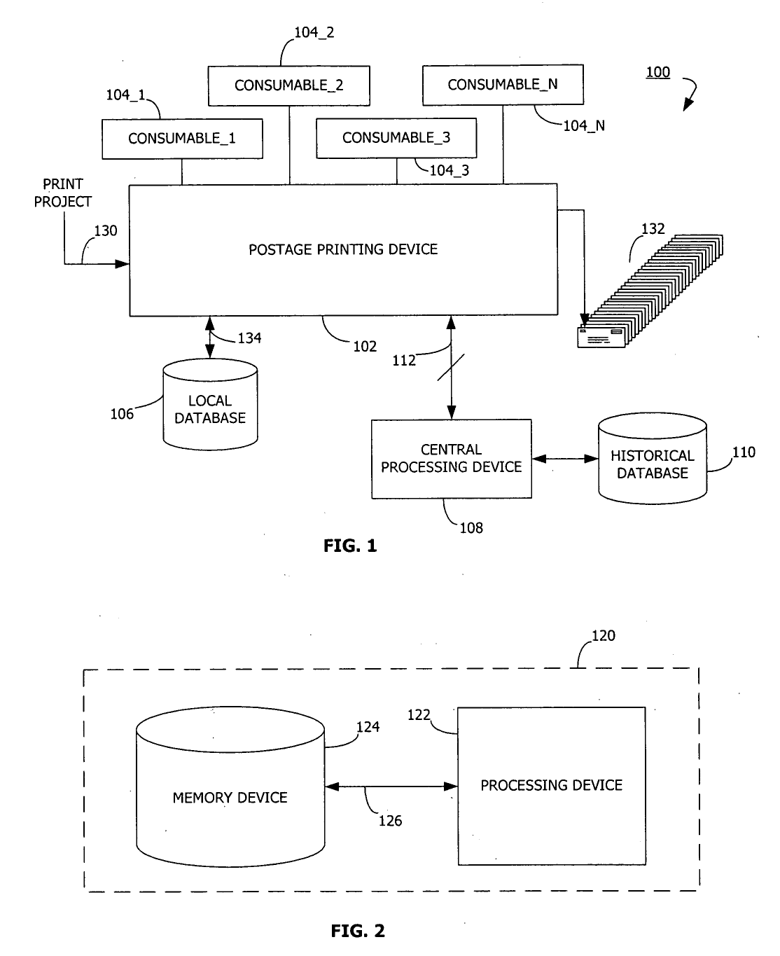

More specifically, FIG. 1 illustrates a mail processing system 100 that can include a postage printing device 102, a plurality of consumable items 104_A, 104_B, 104_C and 104_N (collectively referred to as 104), wherein N equals any suitable integer value, and a local database 106. The postage printing device 102 is in communication with a central processing device 108 coupled to a historical database 110.

The postage printing device 102 may be any suitable printing device usable for printing mailing tasks, including high speed print mailing systems which include hardware for physically performing the tasks of moving paper, envelopes and other components and software for performing the underlying operations. For example, FIG. 2 illustrates a processing system 120 that may be disposed in the postage printing device 102, the system 120 includes a processing device 122 and a memory device 124. The processing device may be one or more processing elements operative to receive executable instructions 126 from the memory device 124 and performing operations as described in further detail below.

Referring back to FIG. 1, the consumables 104 are items that can be expended by the processing system 100 when the printing device 102 performs a print job. These consumables 104 may include any number of elements, such the exemplary items of paper, ink, labels, envelopes and credit or postage money in a PSD device. The local database 106 may be disposed within the postage printing device 102 and may be one or more memory components capable of storing data usable by the device 102, more specifically usable by the processing device 122 of FIG. 2. Similarly, the central processing device 108 may be one or more processing elements operative to perform various computations, as described below. The processing device 108 may be in communication with the postage printing device 102 across a networked connection 112. The historical database 110 may be one or more storage devices operative to store historical data usable by the central processing device.

In one embodiment, the postage printing device 102 can receive a printing job or batch 130 as processing from a database where the project can include instructions as to running a mailing operation including printing items for subsequent mailing, for example printing letters, printing postage for letters on envelopes and thereupon assembling the letters and envelopes for subsequent mailing. Illustrated in FIG. 1, the postage printing device 102 may generate a plurality of mailing components 132, which in the illustrated embodiment include sealed envelopes having postage printed thereon.

The postage printing device 102 may operate any one of numerous embodiments for predicting the usage of the consumables 104. One embodiment includes actively monitoring the actual operating speed of the device 102. This may be performed using an internal routine executable on the processing device 122 that monitors the actual operating speed over a defined period of time. From this time-based examination, a statistically meaningful operating speed of the device 102 can be estimated. For example, an average speed can be estimated, a probability distribution for an operating speed can be derived, etc.

This actual or estimated operating speed may have numerous meanings as it relates to different consumables or affected by different aspects of the print project 130. For example, if the print project includes printing multiple pages for insertion in a single envelope, the operating speed as to the consumable item of paper may different from the operating speed of the consumable item of envelopes or labels. Although, the operating speed can provide a corresponding metric of the realistic operation of the postage printing device 102 as opposed to idealistic operating rates, such as supposed “maximum” or “normal” operating rates provided by the manufacturer of the printing device 102. As described above, the device 102 may include a maximum operating speed, but actual operating speeds vary significantly due to operational aspects, therefore this operating speed is a much more accurate measurement.

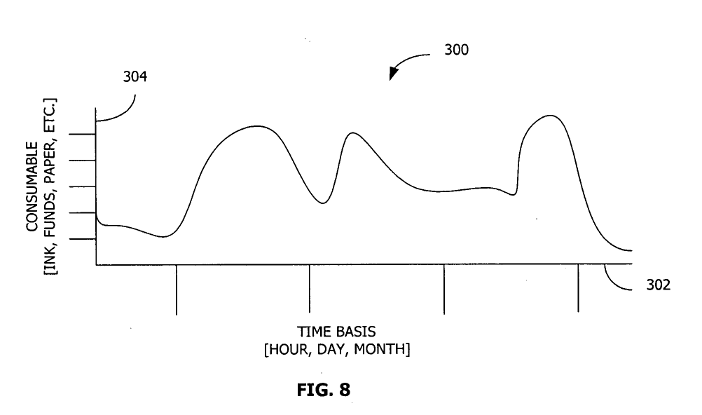

In addition, the operating speed may further include variable speed at various times under a usage profile. FIG. 8 illustrates a sample graph of a usage profile 300 indicating a graphical representation of an operating speed through the usage profile in a comparison of a time basis 302 relative to a consumable basis 304. For example, over different periods of time, such as hours, days, months or any other suitable time interval, the operating speed of the processing system will vary. Therefore, the usage amounts of the consumable, such as ink, funds, paper or any other suitable consumable, also varies. For example, a processing system may have a higher usage profile, indicating more activity, towards the end of a month when bills or other month-end mailings are sent to customer.

Historical data can be used to more accurately predict the operating speed, e.g., the rate at which a consumable will be expended. In one embodiment, historical data 134 can be stored in the local database 106. This historical data 134 may include operational data collected over period of times when the device 102 is operating. This data may also be accumulated in the database 106. As the device 102 continues to operate, the historical data 134 may updated. Thereby, in this embodiment after continued operations, the postage printing device may have a large data set, the historical data 134, from where the operational speed is calculated or averaged. This historical data can be used to indicate, for example, that for print jobs involving less than 1000 pieces, the printing ink at a given location (e.g., cartridge) has been expended at an average rate of 3 ml/min. Standard deviation measures can indicate the consistency with which this has occurred in the past. If five jobs of less than 1000 pieces each are planned, then the cartridge can be predicted to run out of ink (or fall below a given ink threshold) at a time during or after the five print jobs. A confidence measurement of such a prediction can be statistically derived based upon the distribution of the historical data. If the ink is predicted to run out during a print job, the cartridge can be replaced before the job is started, thereby avoiding an interruption of the job. Likewise, historical data can be used to indicate that for print jobs involving 1000-5000 pieces, the ink cartridge expends ink at 2.7 ml/min. This data can be used similarly as described above.

In another embodiment, a further larger scope of historical data 134 may be used with the central processing device 108. As noted above, the central processing device 108 may be in communication through a networked connection 112 and as such may collect historical data 134 from the device 102, as well as other networked devices (not shown). In the central historical database 110, the historical data 134 may be combined with historical data sets from other printing devices 102. With this information, the central processing device 108 may be able to perform different calculations to determine the operating speed. In this embodiment, this can provide an even larger data scope for performing the operating speed calculations. It is noted that the central processing device 108 may also include larger processing capabilities and may be able to perform more advanced data processing techniques to calculate the operating speed than could be available on the local processing device 122 (FIG. 2) in the postage printing device 102.

The postage printing device 102 can also determine the remaining amount or capacity of the consumables. Pinging or otherwise electronically inquiring as to a status amount may determine the remaining amount. Additionally, the consumable carriers may actively supply this information. In another embodiment, the postage printing device 102 may additionally actively monitor these amounts. For example, if the first consumable is a PSD including credits usable for subsequent printing postage by the device 102, the PSD may provide an initial credit amount of the device 102 and the device 102 subtracts the proper credit for each postage printing instruction. In another example, if the consumable is ink cartridge levels, the device 102 may actively inquire as to an ink level. Regardless of the specific technique, the device 102 thereupon determines the remaining amount of the consumable in the processing system 100.

It is further noted that the embodiment disclosed in FIG. 1 includes the postage printing device 102, whereas the mail processing system may also include a system not having a printing component. For example, a processing system may operate to stuff pre-printed documents into envelopes or may operate to fold and apply adhesive to pre-printed flyers.

The processing device 122 of FIG. 2, disposed within the postage printing device 102 of FIG. 1, can calculate a prediction for the predicted expiration of the consumable. The calculation of the prediction term can include referencing the corresponding operating speed relative to the remaining amount of the consumable. This calculation may also include threshold amounts, such as conditions that a consumable supply amount should not fall below a minimum threshold, or other associated parameter. The prediction term may a time-based term. By way of example, if the operating speed relating to a PSD is a certain dollar amount of credits per hour and the PSD indicates a remaining supply of a certain dollar amount of credits, the prediction term may indicate when the PSD will run out of credit, such as in X number of minutes and hours. Additionally, this calculation can be job-specific where different print jobs may utilize varying amounts of the associated consumables. For example, print jobs with larger envelopes may utilize franking operations, and hence credit amounts in PSDs, quicker. Therefore, for this type of print job, the calculation needs to account for the increase usage of consumable, which in this example is credit but it is recognized that each print job can have separate demands and hence varying calculations for the corresponding consumables. In an embodiment not including a printing device, the processing device 122 may be disposed in another processing component in the mail processing system.

The processing device 122 of FIG. 2 thereupon estimates a time to expire for the consumable in the processing system 100. This estimation may be a straight forward calculation of the prediction term to a current time or the estimation may also include additional aspects to the operation of the postage printing device 102, such as the status of a print job or a time of day in the event the system may be shut off and a job completed the following business day, for example. Therefore, through these operations, the printing device 102 proactively determines and monitors the capacity of the consumables 104.

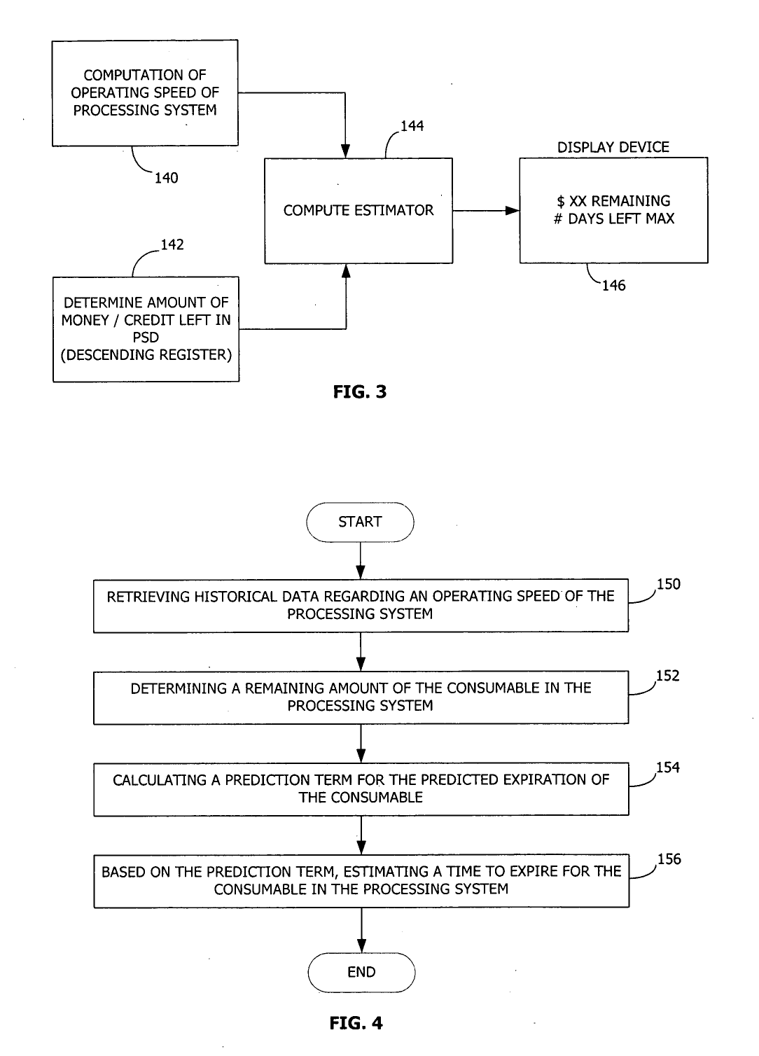

FIG. 3 illustrates a flow diagram of one embodiment of operations performed by the processing device 120 of FIG. 2 within the postage printing device 102 of FIG. 1 where the consumable is money or credit within a PSD. The flow process can include computing the operating speed of the processing system, block 140. As discussed above, this may include, among other available techniques, analyzing historical data, actively monitoring operations over a set period of time or a combination of both. The flow can also include determining an amount of money or credit left in the PSD, such as examining a descending register, block 142.

From both steps 140 and 142, the flow process can include computing an estimate value, block 144. From this estimate value, with reference to the amount of money or credit left in the PSD, the flow process provides for the computation of a time until the PSD is estimated to run out of money or credit. As illustrated in block 146, this may include a visual display of a remaining credit or dollar amount as well as a time indicator, such as X number of days. It is recognized, this technique is equally applicable to all other types of consumable items, such as illustrated in flowchart of FIG. 4.

FIG. 4 illustrates a flowchart of the steps of one embodiment of a method for predicting usage of a consumable in a mail processing system. The steps of this method may be performed in response to executable instructions, such as being performed by the processing device 120 of FIG. 2. In one embodiment, the first step can be retrieving historical data regarding an operating speed of the processing system, step 150. In one embodiment, the historical data may be retrieved from a local or remote storage device.

The next step, step 152, is determining a remaining amount of consumable in the processing system. As discussed above with respect to FIG. 1, this step may be performed by querying a device storing or monitoring the consumable or in another embodiment the processing system itself may be tracking this information. Step 154 can include calculating a prediction term for the predicted expiration of the consumable. This prediction step may be performed by referencing the operating speed relative to the remaining capacity. In this embodiment, step 156 can be estimating a time to expire for the consumable in the processing system, this estimation being based on the prediction term. Similar to step 154, as discussed above relative to FIG. 1, this step may be performed using the time value of the estimated time to expire in comparison to the present time to give a more accurate description of when the consumable may expire. The method can thus provide for the predicting of the usage of the consumable in the mail processing system.

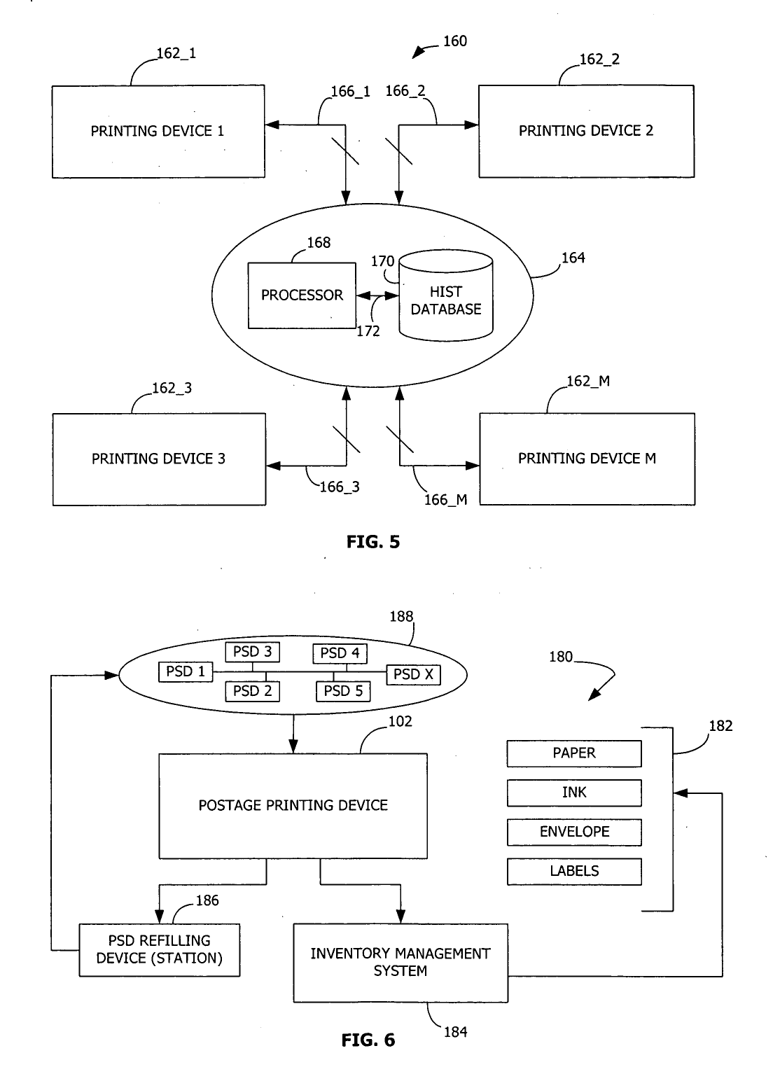

FIG. 5 illustrates an embodiment of a multi-processing system 160 including M number of printing devices 162_1, 162_2, 162_3, 162_M (collectively referred to as 162), where M is any suitable integer. The system 160 can include the printing devices 162 coupled to the central processing system 164 connected through one or more networked connection 166_1, 166_2, 166_3, 166_M (collectively referred to as 166). The central processing system 164 can include the processing device 108 and the historical database 110. It is recognized that many additional elements within the central processing system 164 have been omitted for clarity purposes only. It is further noted that, as discussed above, the system 160 may also include processing devices not including printing components included in the printing devices 162.

Central processing system 164 can include a processor coupled to a memory. The processor can be a general purpose processor, such as an Intel Pentium IV processor manufactured by the Intel Corporation of Santa Clara, Calif. Alternatively, the processor can be an Application Specific Integrated Circuit (ASIC) whose hardware and firmware at least partly embody the method in accordance with an embodiment of the present invention. An example of an ASIC is a digital signal processor. Memory can be any device adapted to store electronic information, such as Random Access Memory, Flash Memory, a hard disk, etc. Memory can include software instructions adapted to be executed by the processor to perform the method in accordance with an embodiment of the present invention. Such software can be distributed by distributing the memory on which it is stored, such as a Compact Disc.

The printing devices 162 may be similar to the processing system 100 of FIG. 1 and can include one or more postage printing devices and ancillary systems complementing operation. These printing devices 162 can include corresponding consumable items usable in normal operation. Similar to the system of FIG. 1, these printing devices 162 may also actively monitor operating speeds and maintain local historical data used for more accurately computing operating speeds. The processing device 108 may be one or more processing devices providing for central computation of historical data 172 stored in the historical database 110.

In the system 160, the printing devices 162 routinely provide historical data to the central processing system 164. In the central processing system 164, higher levels of data computations may be performed using the larger data sets in the historical database 110. In one embodiment, the historical database 110 may store these historical data sets comprising previously computed information. The processing device 108 may update the data sets using any newly received or update historical data from the printing devices 162.

Similarly, during the operation of the printing devices 162, the printing devices 162 may access the processing system 164 to retrieve historical data. The historical data may include processed data, which can be used by the printing device 162 to calculate the operating speed, which may be indicated by a usage profile, such as the profile 300 of FIG. 8. In the embodiment of FIG. 5, the historical data used by each of the printing devices 162 may include historical data from the related printing devices 162. Therefore, this may provide a more accurate operating speed and thus more accurate prediction term, based on a larger data set in the historical database 110.

FIG. 6 illustrates another embodiment. The system 180 includes the postage printing device 102, as described above in FIG. 1, which may also be a mail processing device or system not including a printing component. The system further includes a plurality of consumable items 182, including the exemplary items of paper, ink, envelopes and labels. Coupled to the postage printing device is an inventory management system 184 and a PSD refilling device or station 186. In this embodiment, the PSD refilling station is coupled to a PSD bank 188 including X number of PSDs, where X may be any suitable integer value.

In this embodiment, the postage printing device 102 can operate similar to the system shown in FIG. 1. Although, in addition, the inventory management system 184 may be a separate processing routine or software application. In a typical embodiment, the inventory management system 184 tracks the amount of inventory left, including beyond just the direct amount associated with the postage printing device 102. For example, the inventory management system 184 may include referencing a storage or warehouse application to indicate that a certain number of ink cartridges, labels, envelopes or paper are in stock. This system may also include provisions for automating or maintaining supply, such as re-ordering consumables when a stock amount gets below threshold levels. For example, ordering replacement amounts of consumables may be an automated function or may include user-directed instructions or user-interface operations, such as a reminder or user-request to confirm the ordering of depleted consumable reserves.

As to the PSD bank 188, this may include any number of PSDs readily available across a networked connection allowing for the postage printing device 102 to withdraw credit for actively printing postage on mailing devices. In normal operations, the PSDs can contain credit amounts and can be periodically refilled. In a PSD bank operation, the postage printing device 102 may be able to select from one or more available PSDs. Therefore, predicted expiration terms may apply to various or all of the PSDs in the bank itself.

In this embodiment, the postage printing device 102 may share information with the PSD refilling station 186 or the inventory management system 184 regarding the predicted depletion of storage amounts of corresponding consumables.

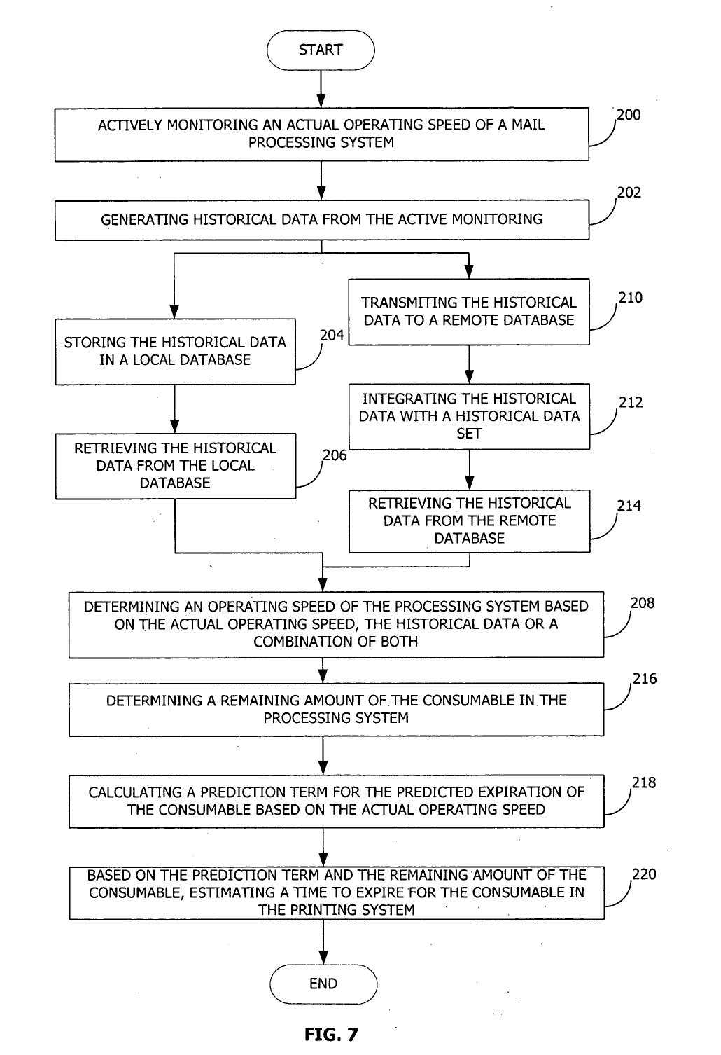

FIG. 7 illustrates the steps of another embodiment of a method for predicting usage of a consumable in a mail processing system. This embodiment of the method can actively monitor an actual operating speed of the mail processing system, step 200. Step 202 can include generating historical data from the active monitoring. This historical data can indicate the operating speed of the postage printing device over the time periods and may also include operating speeds as to particular components or consumables in the device, for example the usage speed of paper may be faster than the usage speed of envelopes for multi-page print jobs.

Historical data can be stored in a local database, step 204. As described above, this information may be locally stored, where the local database may also being stored previous historical data and the new data is then combined or merged in the database. The historical data can be retrieved from the local database, step 206, which may include all or a portion of the historical data stored therein, not just the historical data written therein in step 204. An operating speed of the processing system can be determined, step 208, based on the actual operating speed, historical data or a combination of both. Additionally, the operating speed may be indicated as a usage profile, such as the profile 300 of FIG. 8.

As illustrated in the flowchart of FIG. 7, an alternative embodiment of this method may include instead of, or in addition to, steps 204 and 206, transmitting the historical data to a remote database, step 210, such as the database 110 of FIGS. 1 and 5. This data may be integrated with a historical data set, step 212 and historical data can be retrieved from the remote database, step 214.

The operating speed of the processing system can be determined, step 208. A remaining amount of consumable in the processing system can be determined, step 216, e.g., based upon the determined operating speed and information about the remaining amount of consumables, historical data, etc. This can be similar to step 152 of FIG. 4. A prediction term can be calculated for the predicted expiration of the consumable based on the actual operating speed, step 218, and a time to expire can be estimated for the consumable in the processing system based on the prediction term and the remaining amount of consumable, step 220. This can be similar to steps 154 and 156 of FIG. 4.

Thereby, through the analysis of historical data or the active monitoring of the operating speed of the mail processing system, the system knows a more accurate estimate of its actual operating speed and the actual rate at which it is expending consumables. Whereas previously, the system could rely on theoretical “maximum” operating speeds to estimate the rate at which consumables are being expended, this was prone to inaccuracy. Tracking the actual operating speed helps to more accurately predict the expiration of various consumable items used in conjunction with the system. Therefore, based on this information, the mail processing system can accurately provide an estimated time until the expiration of the consumables. With this accurate expiration estimation, the operator may more effectively prevent the exhaustion of any associated consumables during a mail processing job or a print run.

It will be understood by those of skill in the art that that the above description is meant to illustrate, and not limit, the scope of the claimed invention. Those of skill in the art will recognize that there exist other implementations of the invention and its various aspects and that the invention is not limited by specific embodiments described herein. It is therefore contemplated to cover any and all modifications, variations or equivalents that fall within the scope of the basic underlying principals disclosed and claimed herein.

What is claimed is:

1. A method for predicting usage of a consumable in a mail processing system, the method comprising:
retrieving historical data regarding an operating speed of the processing system;
determining a remaining amount of the consumable in the processing system;
calculating a prediction term for the predicted expiration of the consumable; and
based on the prediction term, estimating a time to expire for the consumable in the processing system.

2. The method of claim 1 further comprising:
actively monitoring an actual operating speed of the processing system; and
updating the determined operating speed of the processing system based on the actual operating speed.

3. The method of claim 1 further comprising:
monitoring a usage profile of the processing system over a defined time period;
calculating the historical data based on the usage profile and the defined time period; and
storing the historical data in a local storage device.

4. The method of claim 3 further comprising:
providing the historical data to a central processing device;
integrating the historical data with at least one existing historical data set.

5. The method of claim 4 wherein the step of retrieving the historical data includes retrieving the historical data integrated with the historical data set.

6. The method of claim 1 wherein the consumable is at least one of: a credit amount in a postage security device (PSD) used by the processing system, ink, envelopes, paper and labels.

7. The method of claim 6 wherein the step of determining the remaining capacity of the consumable includes referencing an inventory database to determine the remaining capacity beyond just the consumable within the processing system.

8. The method of claim 7 further comprising:
ordering the consumable when a remaining capacity is below a threshold level.

9. An apparatus for predicting usage of a consumable in a mail processing system, the apparatus comprising:
a memory device having executable instructions stored therein and
a processing device coupled to the memory device and receiving the executable instructions therefrom, the processing device in response to the executable instructions, operative to:
retrieve historical data regarding an operating speed of the processing system;
determine a remaining amount of the consumable in the processing system;
calculate a prediction term for the predicted expiration of the consumable; and
based on the prediction term, estimate a time to expire for the consumable in the processing system.

10. The apparatus of claim 9, the processing device further operative to:
actively monitor an actual operating speed of the processing system; and
update the determined operating speed of the processing system based on the actual operating speed.

11. The apparatus of claim 9, further comprising:
a local storage device; and
wherein the processing device is further operative to:
monitor a usage profile of the processing system over a defined time period;
calculate the historical data based on the usage profile and the defined time period; and
store the historical data in the local storage device.

12. The apparatus of claim 11 wherein the processing device is further operative to:
provide the historical data to a central processing device;
associate the historical data with at least one existing historical data sets.

13. The apparatus of claim 12 wherein when the processing device retrieves the historical data, the processing device retrieves the historical data integrated with the historical data set.

14. The apparatus of claim 10 wherein the consumable associated with the processing system is at least one of: a credit amount in a postage security device (PSD), ink, envelopes, paper and labels.

15. The apparatus of claim 9 wherein the processing device is further operative to reference an inventory database to determine the remaining capacity of consumable beyond just the consumable within the processing system.

16. The apparatus of claim 15 wherein the processing device is further operative to order the consumable when a remaining capacity is below a threshold level.

17. A system for predicting consumable usage comprising:
a mail processing system including a plurality of consumables;
a processing device in operative communication with the processing system,
the processing device in response to executable instructions operative to:
actively monitor an actual operating speed of the mail processing system;
determine an operating speed of the processing system based on the actual operating speed;
determine a remaining amount of the consumable in the processing system;
calculate a prediction term for the predicted expiration of the consumable based on the operating speed; and
based on the prediction term and the remaining amount of the consumable, estimate a time to expire for the consumable in the processing system.

18. The system of claim 17 further comprising:
a local data storage device; and
the processing device further operative to:
monitor the usage profile of the postage system over a defined time period to generate historical data and store the historical data in the local data storage device such that the historical data is retrieved from the local data storage device and used in determining the operating speed of the processing system.

19. The system of claim 17 further comprising:
a remote data storage device having a historical data set stored therein;
the processing device further operative to monitor the usage profile of the processing system over a defined time period to generate historical data and transmit the historical data to the remote data storage device; and
a remote processing device operative to integrate the historical data with the historical data set such that the processing device is further operative to retrieve the historical data includes the historical data set to be used in determining the operating speed of the processing system.

20. The system of claim 17 further comprising:
a postage security device (PSD) used by the processing system such that the consumable is a credit amount in the PSD.

21. The system of claim 17 wherein the consumable may be one of: ink, envelopes, paper and labels.

22. The system of claim 17 further comprising:
an inventory management system such that when the processing device is operative to determine the remaining capacity of the consumable, this determination includes referencing the inventory management system to determine the remaining capacity beyond just the consumable associated with the processing system and the inventory management system is operative to order the consumable when a remaining capacity is below a threshold level.
